(19) United States
(12) Patent Application Publication
(10) Pub. No.: US 2009/0162536 A1
(43) Pub. Date: Jun. 25, 2009

(54) METHOD FOR FORMING FILM PATTERN, METHOD FOR FORMING CONTACT HOLE, METHOD FOR FORMING BUMP, AND METHOD FOR MANUFACTURING LIGHT EMITTING DEVICE

(75) Inventors: Toshimitsu HIRAI, Hokuto (JP); Jun YAMADA, Shiojiri (JP); Tsuyoshi SHINTATE, Sakata (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/338,194

(22) Filed: Dec. 18, 2008

(30) Foreign Application Priority Data
Dec. 25, 2007 (JP) 2007-331589

(51) Int. Cl. B05D 5/12

(52) U.S. Cl. 427/77; 427/256

(57) ABSTRACT

A method for forming a film pattern disposed adjacent to a pattern non-forming region by coating a pattern forming region with a functional liquid, includes (a) forming a liquid repellent film by coating the pattern non-forming region with a droplet containing a liquid repellent material having repellency to the functional liquid, and (b) forming the film pattern by coating the pattern forming region adjacent to the liquid repellent film with the functional liquid. The step (a) of forming of the liquid repellent film and the step (b) of forming of the film pattern are alternately repeated at least two times, respectively.

### BACKGROUND

1. Technical Field

The present invention relates to a film pattern forming method for forming a film pattern by discharging a droplet, a method for forming a contact hole using the same, a method for forming a bump, and a method for manufacturing a light emitting device.

2. Related Art

In recent years, a film forming technique using a droplet discharge method (ink-jet method) is attractive. The film forming technique has features that fine liquid materials can be precisely applied to desired positions by means of an ink-jet head so that various shapes of fine film patterns can be formed. For example, a fine wiring pattern, an insulation film pattern or the like can be formed on a circuit substrate by applying a desired functional liquid. JP-A-2007-53333 is an example of related art.

Sometimes, a film pattern formed by the above film forming technique requires a prescribed thickness depending on a specification. In a case where a thickness of a film pattern formed by a film forming technique using the liquid discharging method is increased in response to the requirement, by repeating a process of forming the film pattern in a prescribed shape, a new film pattern is formed on the previously formed film pattern to sequentially laminate the film patterns, thereby forming the film pattern with the desired thickness.

However, the increase of the thickness of the film pattern may cause a problem that, for example, in a region where an underlayer of a contact hole section should be exposed or a region where an outer fringe of the film pattern should be precisely formed on a circuit substrate, a functional liquid repeatedly applied for the lamination flows and spreads from the portion on the film pattern on which the functional liquid is applied into the above described region (pattern non-forming region) which must not be wetted by the spreading functional liquid, and then the desired film pattern is not obtained.

### SUMMARY

An advantage of the present invention is to provide a film pattern forming method for forming a film pattern with a desired thickness, a method for forming a contact hole using the same, a method for forming a bump, and a method for manufacturing a light emitting device by preventing a functional liquid for forming the film pattern from flowing into a pattern non-forming region.

A method for forming a film pattern on a pattern forming region disposed adjacent to a pattern non-forming region by coating the pattern forming region with a functional liquid according to a first aspect of the invention, has a constitution that includes (a) forming a liquid repellent film by coating the pattern non-forming region with a droplet containing a liquid repellent material having repellency to the functional liquid, and (b) forming the film pattern by coating the pattern forming region adjacent to the liquid repellent film with the functional liquid. The step (a) of forming the liquid repellent film and the step (b) of forming the film pattern are alternately repeated at least two times, respectively.

By adopting the above constitution, the liquid repellent film is sequentially formed on the pattern non-forming region together with the film pattern so that it is possible to form the liquid repellent film with the thickness corresponding to that of the laminated film pattern. The film pattern in the invention is in a concept including not only a pattern formed in a film, but also a pattern formed in a layer.

In addition, the step (a) of forming of the liquid repellent film of the invention may have a constitution that the liquid repellent film is formed in a line along a boundary between the pattern non-forming region and the pattern forming region.

By adopting the above constitution, the liquid repellent film is sequentially formed so as to be in contact with the film pattern, thereby it is possible to prevent the functional liquid from flowing into the pattern non-forming region from the laminated film pattern.

In addition, the method for forming a film pattern of the invention further may have a constitution that includes (c) removing the liquid repellent film after forming the film pattern with the prescribed thickness and (d) forming the second film pattern by coating the pattern non-forming region with the second functional liquid, the pattern non-forming region being obtained by removing the liquid repellent film in the step (c) of removing of the liquid repellent film.

By adopting the above constitution, the desired second film pattern is formed on the pattern non-forming region after forming the film pattern with the prescribed thickness, thereby the film pattern having a desired function can be formed.

According to a second aspect of the invention, a method for forming a contact hole is achieved by using the above described method for forming a film pattern.

By adopting the above constitution, it is possible to form the contact hole having a desired diameter and a desired depth by using the above described film pattern forming method.

According to a third aspect of the invention, a method for forming a bump is achieved by using the above described method for forming a film pattern.

By adopting the above constitution, it is possible to form the bump having a desired thickness by using the above described film pattern forming method.

According to a fourth aspect of the invention, a method for manufacturing a light emitting device which is configured of a cathode section having an electron emitting member, an electrode member for allowing the electron emitting member to emit electrons and an insulation film with a prescribed thickness provided between the electron emitting device and the electrode member, and an anode section for emitting light by the emitted electrons, has a constitution that includes (e) forming the insulation film by the pattern forming method according to the first aspect of the invention.

By adopting the above constitution, it is possible to form the insulation film with the desired thickness by using the above described film pattern forming method.

The method for manufacturing a light emitting device according to the invention, further may have a constitution that includes (f) forming an electrode film by coating a portion on the insulation film with a droplet containing an electrode material to be the electrode member after the step (c) of forming the insulation film with a prescribed thickness, (g) removing the liquid repellent film formed in the step (a) of forming of the liquid repellent film after the step (f) of forming the electrode film, and (h) forming an electron emitting film by coating the pattern non-forming region with a droplet containing an electron emitting material to be the electron emitting member. The pattern non-forming region is formed by removing the liquid repellent film in the step (g).

By adopting the above constitution, it is possible to form the electrode film and the electron emitting film by using the above described film pattern forming method, thereby the cathode section of the light emitting device can be manufactured.

### BRIEF DESCRIPTION OF THE DRAWINGS

The invention will be described with reference to the accompanying drawings, wherein like numbers reference like elements.

FIG. 1 is a schematic view illustrating a structure of a droplet discharge device used in an embodiment of the invention.

FIG. 2 is a sectional view of a droplet discharge head used in an embodiment of the invention.

FIG. 3A is a plan view illustrating a substrate on which a film pattern is formed in an embodiment of the invention.

FIG. 3B is a sectional view along a line A-A of the substrate.

FIGS. 4A through 4C are plan views for explaining processes of forming a film pattern of the invention.

FIGS. 5A through 5D are sectional views for explaining processes of forming a film pattern of the invention.

FIG. 6 is a sectional view illustrating a light emitting device of an embodiment of the invention.

FIG. 7 is a plan view illustrating a cathode device of an embodiment of the invention.

FIGS. 8A and 8B are plan views illustrating a substrate having formed thereon a film pattern of another embodiment of the invention.

FIG. 9 is a sectional view illustrating a contact hole and a bump formed on the substrate of another embodiment of the invention.

### DESCRIPTION OF EXEMPLARY EMBODIMENTS

The preferred embodiments of the method for forming a film pattern, and the method for manufacturing a light emitting device of the invention will be described with reference to the accompanying drawings.

It should be noted that different scales are used for the members in the drawings so that each member can be recognized.

Droplet Discharge Device

First, a droplet discharge device which is used in the method for forming a film pattern in the embodiment of the invention, will be described below.

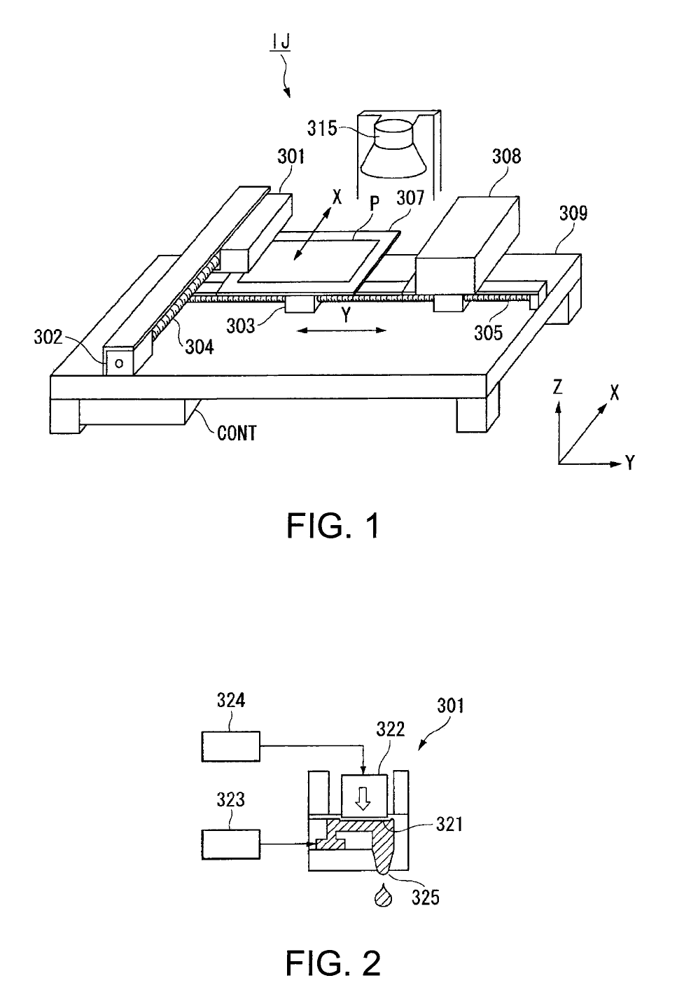

FIG. 1 is a schematic view illustrating a structure of a droplet discharge device used in an embodiment of the invention. The droplet discharge device (inkjet device) IJ is adapted to discharge (drop) a droplet to a substrate P from a droplet discharge head, and is equipped with the droplet discharge head 301, an X-direction drive shaft 304, a Y-direction guide shaft 305, a control device CONT, a stage 307, a cleaning mechanism 308, a base 309, and a heater 315.

The stage 307 is adapted to support the substrate P to which ink (a liquid material) is applied by the droplet discharge device IJ, and is equipped with a fixing mechanism (not shown) for fixing the substrate P to a reference position.

The droplet discharge head 301 is a multi-nozzle type droplet discharge head including a plurality of discharge nozzles. The longitudinal direction of the head 301 is coincident with an X-axis direction. The plurality of discharge nozzles are arranged at a prescribed interval in the X-axis direction at the lower face of the droplet discharge head 301. The ink is discharged from the discharge nozzles of the droplet discharge head 301 to the substrate P supported by the stage 307.

An X-direction drive motor 302 is coupled to the X-direction drive shaft 304. The X-direction drive motor 302 is a stepping motor, for example, and rotates the X-direction drive shaft 304 when the control device CONT supplies a drive signal for the X-direction to the drive motor 302. By rotating the X-direction drive shaft 304, the droplet discharge head 301 is moved in the X-axis direction.

The Y-direction guide shaft 305 is fixed to the base 309 so as not to move with respect to the base 309. The stage 307 is equipped with the Y-direction drive motor 303. The Y-direction drive motor 303 is a stepping motor, for example, and moves the stage 307 in the Y-direction when the control device CONT supplies a drive signal for the Y-direction to the drive motor 303.

The control device CONT supplies a voltage for controlling the discharging of the droplets to the droplet discharge head 301. The control device CONT supplies a drive pulse signal for controlling the movement of the droplet discharge head 301 in the X-direction to the X-direction drive motor and supplies a drive pulse signal for controlling the movement of the stage 307 in the Y-direction to the Y-direction drive motor 303.

A cleaning mechanism 308 is adapted to clean the droplet discharge head 301. The cleaning mechanism 308 is equipped with a drive motor (not shown) for the Y-direction. By driving the Y-direction drive motor, the cleaning mechanism 308 is moved along the Y-direction guide shaft 305. The controller CONT also controls the movement of the cleaning mechanism 308.

The heater 315, here, is means to apply heat treatment to the substrate P by lump annealing, and evaporates and dries a solvent contained in a liquid material applied to the substrate P. The controller CONT also controls turning on and off of a power supply of the heater 315.

The droplet discharge device IJ discharges droplets to the substrate P while relatively scanning the stage 307 supporting the substrate P with the droplet discharge head 301. Here, the X-direction is referred to as a non-scanning direction and the Y-direction perpendicular to the X-direction is referred to as a scanning direction.

The discharge nozzles of the droplet discharge head 301 are arranged at a prescribed interval in the X-direction, i.e., the non-scanning direction. While the droplet discharge head 301 is disposed at a right angle with respect to the moving direction of the substrate P in FIG. 1, the angle of the droplet discharge head 301 can be adjusted such that the droplet discharge head 301 intersects the moving direction of the substrate P. Accordingly, a pitch between the discharge nozzles can be adjusted by adjusting the angle of the droplet discharge head 301. In addition, the distance between the substrate P and the nozzle face of the head 301 can be arbitrarily adjusted.

FIG. 2 is a sectional view of the droplet discharge head 301. A piezo element 322 is disposed adjacent to a liquid chamber 321 that stores a liquid material (functional liquid) in the droplet discharge head 301. The liquid material is supplied to the liquid chamber 321 through a liquid material supply system 323 including a material tank that stores the liquid material.

The piezo element 322 is connected to a drive circuit 324. A voltage is applied to the piezo element 322 via the drive circuit 324 so as to deform the piezo element 322, thereby the liquid chamber 312 is deformed to discharge the liquid material from the nozzle 325. In this case, a strain amount of the piezo element 322 is controlled by varying a value of the applied voltage. In addition, a strain velocity of the piezo element 322 is controlled by varying a frequency of the applied voltage.

While no heat is applied to the liquid material in the event of discharging the droplet by the piezo method, the method has an advantage of hardly giving adverse effect on a composition of the liquid material.

As the discharge technique in the droplet discharge method, in addition to the above electromechanical conversion method, a charge control method, a pressure vibration method, an electrothermal conversion method, and an electrostatic attraction method can be listed.

In the charge control method, an electric charge is applied to a material by a charge electrode and a flying direction of the material is controlled by a deflection electrode, thereby the material is discharged from a nozzle.

In addition, in the pressure vibration method, a material is applied with an ultra high pressure of, for example, 30 kg/cm² to be discharged toward a tip side of a nozzle. When a control voltage is not applied, the material goes straight to be discharged from the nozzle. When the control voltage is applied, electrostatic repulsion occurs between the materials to scatter the materials so that the materials are not discharged from the nozzle.

In the electrothermal conversion method, a material is rapidly evaporated to generate a bubble by a heater provided in a space reserving the material, thereby the material in the space is discharged by the pressure of the bubble.

In the electrostatic attraction method, a small pressure is applied to a space reserving a material to form a meniscus of the material on a nozzle. In this condition, an electrostatic attractive force is applied to the material, thereby drawing the material. In addition, techniques of a method for utilizing variation in viscosity of a fluid due to an electric field and a method for discharging a material by discharging of spark can be adaptable to the invention.

The droplet discharge method has an advantage that the material can be used without waste and a desired amount of material can be adequately disposed on a desired position. An amount of one droplet of the liquid material (fluid material) discharged by the droplet discharge method is, for example, in a range of 1 to 300 nanograms.

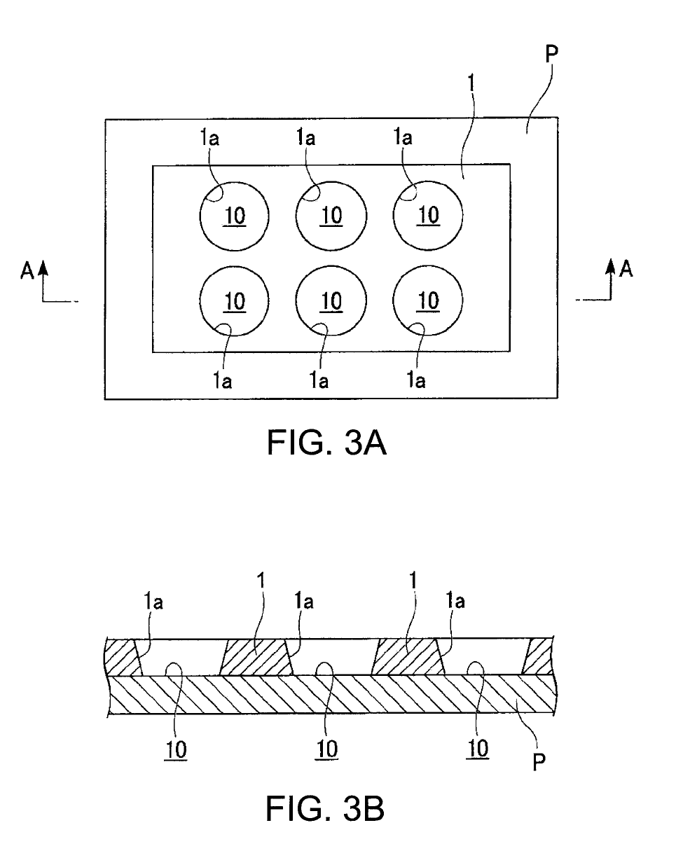

Next, the film pattern formed by the droplet discharge device IJ in the above structure will be described below with reference to FIGS. 3A and 3B. FIG. 3A is a plan view illustrating the substrate P on which the film pattern 1 is formed in an embodiment of the invention. FIG. 3B is a sectional view along the line A-A in FIG. 3A. The film pattern 1 is formed to be in a roughly rectangular shape on the substrate P at the plane face, and hole parts 1a are formed so as to expose a plurality of circular pattern no-forming regions 10 residing in the inner side of a region where the rectangular pattern is formed as shown in FIG. 3A. The film pattern 1 is formed to be in a prescribed thickness (for example, approximately 10 μm) as shown in FIG. 3B. The film pattern 1 is an insulation film formed of, for example, polyimide or the like.

As the substrate P, materials such as glass, quartz glass, an Si wafer, a plastic film, a metal plate can be used. The material having a semiconductor film, a metal film, a dielectric film, an organic film or the like formed on the surface of the above material can be included as the substrate P.

Film Pattern Forming Method

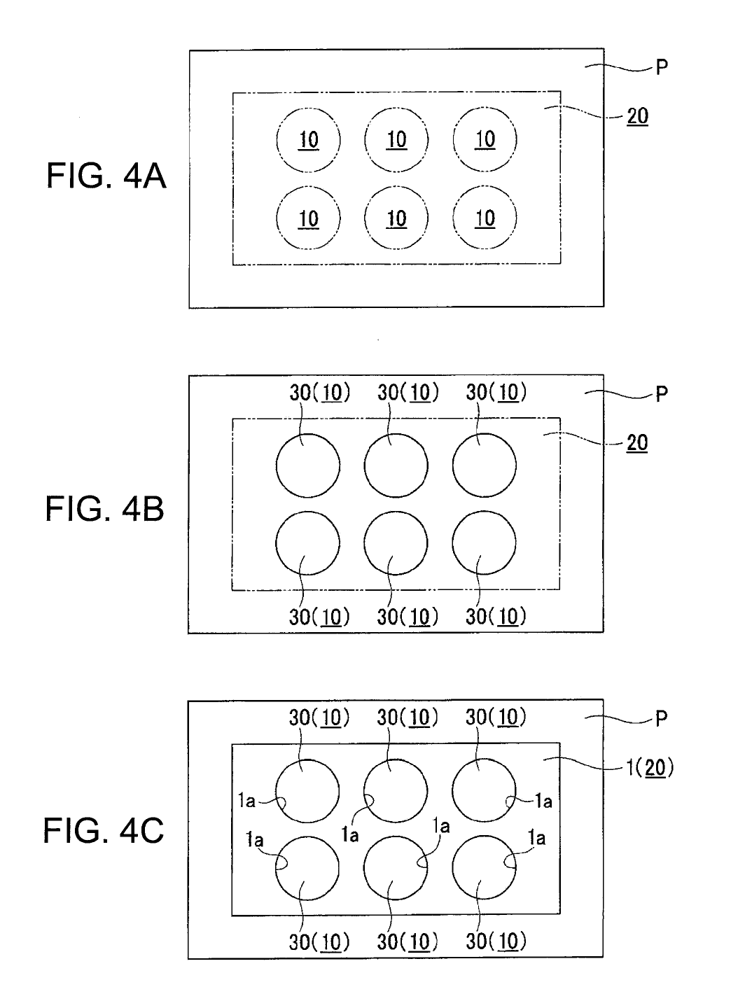

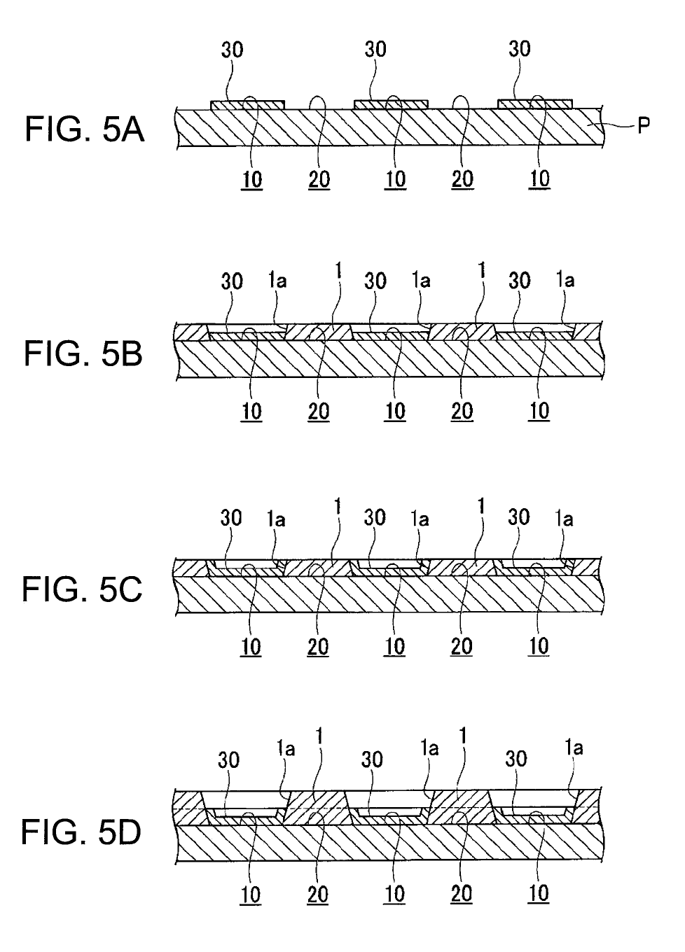

Next, a method for forming the film pattern with a thickness by using the droplet discharge device IJ in the above structure will be explained below with reference to FIGS. 4A, 4B, 4C, 5A, 5B, 5C and 5D. FIGS. 4A through 4C are plan views for explaining processes of forming the film pattern 1 of the invention. FIGS. 5A through 5D are sectional views for explaining processes of forming the film pattern 1 of the invention.

As shown in FIG. 4A, the pattern forming region 20 to which the film pattern 1 is to be formed is provided adjacent to the pattern non-forming region 10 on the substrate P. It is preferable to apply treatment for raising lyophilicity to the pattern forming region 20, beforehand because the region 20 is one on which a droplet of the functional liquid for forming the film pattern 1 is to be discharged by the droplet discharge device IJ. As cleaning treatment of the surface of the substrate P for raising the lyophilicity, specifically, UV excimer cleaning, low pressure mercury lamp cleaning, O₂ plasma cleaning, acid cleaning using HF, sulfuric acid or the like, alkali cleaning, ultrasonic cleaning, megasonic cleaning, corona treatment, glow cleaning, scrub cleaning, ozone cleaning, hydrogen water cleaning, micro bubble cleaning, fluorine type cleaning or the like can be carried out.

Liquid Repellent Film Forming Process

Next, as shown in FIG. 4B, the substrate P of which the surface is made to be lyophilic by the cleaning treatment is coated with a droplet including a liquid repellent material having the liquid repellency to the functional liquid for forming the film pattern 1 so as to cover the pattern non-forming region 10 by the droplet discharge device IJ, and then drying (baking) treatment is applied to the substrate P, thereby a liquid repellent film 30 is formed.

Specifically, in the droplet discharge device IJ, the substrate P is loaded on the stage 307 as shown in FIG. 1, and the droplet discharge device IJ discharges the liquid including the liquid repellent material from the discharge nozzle while relatively scanning the stage 307 supporting the substrate P with the droplet discharge head 301 under the controlling of the control device CONT, thereby forming the liquid repellent film 30 on the pattern non-forming region 10.

Thus, as shown in FIG. 5A, the liquid repellent film 30 is formed on the substrate P with a prescribed thickness.

As the liquid repellent material showing the liquid repellency, a silane compound, a compound including a fluoroalkyl group, a fluororesin (resin including fluorine) and a mixture of the above compounds can be used. By using the silane compound as the liquid repellent material, a self-assembled monolayer of the silane compound is formed on the deposited position so that it is possible to give superior liquid repellency to the surface of the film.

In addition, a silane compound including fluorine (liquid repellent silane compound) can be used. As the silane compound including fluorine, for example, a fluorine-containing alkylsilane compound can be listed. By coating the substrate P with the fluorine-containing alkylsilane compound to form the liquid repellent film 30, the compound is oriented such that the fluoroalkyl group is disposed on the surface of the film to form the self-organization film so that it is possible to give the superior liquid repellency to the substrate P by the surface of the film.

In a case where the fluororesin is used to form the liquid repellent film 30, a material having a prescribed solvent in which a prescribed amount of fluororesin is dissolved can be used. Specifically, a material of “EGC1720” made by Sumitomo 3M Co., Ltd. (in which the fluororesin of 0.1 w % is dissolved in an HFE (Hydro Fluoro Ether) solvent) or the like can be used. When using a kind of the fluororesin which requires heating and polymerizing in order to exhibit the liquid repellency, heating, for example, at temperature of 150 to 200° C. is applied to polymerize the resin including fluorine, thereby the liquid repellency can be exhibited.

Film Pattern Forming Process

Next, as shown in FIG. 4C, the substrate P on which the liquid repellent film 30 is formed at the pattern non-forming region 10 in the liquid repellent film forming process, is coated with the functional liquid (liquid including polyimide in this embodiment) for forming the film pattern 1 by the droplet discharge device IJ so as to cover the pattern forming region 20, thereby forming the film pattern 1. Specifically, the droplet discharge device IJ discharges the functional liquid while relatively scanning the stage 307 supporting the substrate P with the droplet discharge head 301 under the controlling of the control device CONT such that the pattern forming region 20 of the substrate P is coated with the functional liquid discharged from the discharge nozzle reserving the functional liquid for forming the film pattern.

Specifically, the droplet discharge device IJ discharges the functional liquid while relatively scanning the stage 307 supporting the substrate P with the droplet discharge head 301 under the controlling of the control device CONT such that the pattern forming region 20 of the substrate P is coated with the functional liquid for forming the film pattern discharged from the discharge nozzle reserving the functional liquid.

The applied functional liquid spreads to wet the whole part of the pattern forming region 20 because the pattern forming region 20 has the lyophilicity, and flowing of the functional liquid to the pattern non-forming region 10 is prevented by the liquid repellent film 30 formed on the pattern non-forming region 10 adjacent to the pattern forming region 20 so that the pattern forming region 20 is coated with the functional liquid with the entirely uniform thickness. In addition, the functional liquid is subjected to the desired heat treatment and irradiated with UV (ultraviolet) rays at the pattern forming region 20 to be dried or cured, thereby the film pattern 1 with the prescribed thickness is formed on the substrate P as shown in FIG. 5B.

Here, in a case where the thickness of the film pattern 1 is to be further increased, if the thickness of the film pattern 1 exceeds the height of the liquid repellent film 30, it is difficult to suppress the flowing of the functional liquid applied to the film pattern 1 next time by the liquid repellent film 30. Therefore, the following process may be carried out.

Liquid Repellent Film Forming Process (The Second Time)

As shown in FIG. 5C, the substrate P on which the film pattern 1 is formed at the patter forming region 20 in the film pattern forming process, is coated with the droplet including the functional liquid, again by the droplet discharge device IJ so as to cover the pattern non-forming region 10, and then the liquid repellent film 30 is formed after the desired drying (baking) treatment is applied to the substrate P. The liquid repellent film 30 which is formed in the liquid repellent film forming process at the second time, is made to be along the side face of the hole section 1a of the film pattern 1 and formed until the height of the thickness of the film pattern 1.

As the liquid repellent film 30 is already formed on the pattern non-forming region 10, it is preferable that the coating of the droplet including the liquid repellent material at the second time is carried out such that the liquid repellent material is in contact with the outer edge of the film pattern 1 in order to save the liquid repellent material.

Film Pattern Forming Process (The Second Time)

In the second liquid repellent film forming process, the droplet discharge device IJ applies the functional liquid on the film pattern 1 in the substrate P on which the liquid repellent film 30 is already formed such that the functional liquid is applied until the height of the film thickness of the film pattern 1 as shown in FIG. 5D. As a result, the film pattern 1 with a prescribed thickness is further laminated on the film pattern 1, thereby forming the film pattern 1 with the large thickness. At that time, the functional liquid applied on the film pattern 1 is prevented from flowing into the pattern non-forming region 10 from the portion on the film pattern 1 because the liquid repellent film 30 is formed so as to correspond to the thickness of the film pattern 1.

In a case where the thick film pattern 1 is further formed, the above liquid repellent film forming process and film pattern forming process are alternately repeated to laminate the film patterns 1 and to sequentially form the liquid repellent film 30 so as to correspond to the thickness of the film pattern 1, thereby the film pattern 1 with the desired thickness can be formed. After the film pattern 1 with the desired thickness is formed, the liquid repellent film 30 is removed by the UV irradiation or the like on the pattern non-forming region 10, thereby the film pattern 1 can be formed as shown in FIG. 3 (a liquid repellent film removing process).

Accordingly, it is possible to achieve by the above described embodiment, the film pattern forming method for providing the pattern forming region 20 adjacent to the pattern non-forming region 10 and forming the film pattern 1 by applying the functional liquid on the pattern forming region 20. The film pattern forming method has a constitution that includes the liquid repellent film forming process of forming the liquid repellent film 30 by applying the droplet including the liquid repellent material having the repellency against the functional liquid to the pattern non-forming region 10, and the film pattern forming process of forming the film pattern 1 by applying the functional liquid to the pattern forming region 20 adjacent to the liquid repellent film 30. The above described liquid repellent film forming process and the above described film pattern forming process are repeated at least two times, respectively. By adopting the above constitution, the liquid repellent films 30 is sequentially formed on the pattern non-forming region 10 together with the laminated film pattern 1, thereby the liquid repellent film 30 with the thickness corresponding to the thickness of the laminated film pattern 1 can be formed.

Accordingly, the method has an effect on suppressing the flowing of the functional liquid for forming the film pattern 1 into the pattern non-forming region 10 and forming the film pattern with the desired thickness.

The above described method for forming the film pattern 1 has a constitution that includes a second film forming process in which after the film pattern 1 with the prescribed thickness is formed, the pattern non-forming region 10 of which the liquid repellent film 30 is removed by the above described liquid repellent film removing process, is coated with a second functional liquid to form a second film pattern. By adopting the above constitution, as the desired second film pattern is formed on the pattern non-forming region 10 after forming the film pattern 1 with the prescribed thickness, it is possible to form the film pattern 1 provided with a function having another prescribed characteristic.

Specifically, after removing the liquid repellent film 30, the pattern non-forming region 10 on which the liquid repellent film 30 resided, is coated with the second functional liquid different from the functional liquid for forming the film pattern 1, thereby giving a new functionality to the substrate P.

Method for Manufacturing a Light Emitting Device

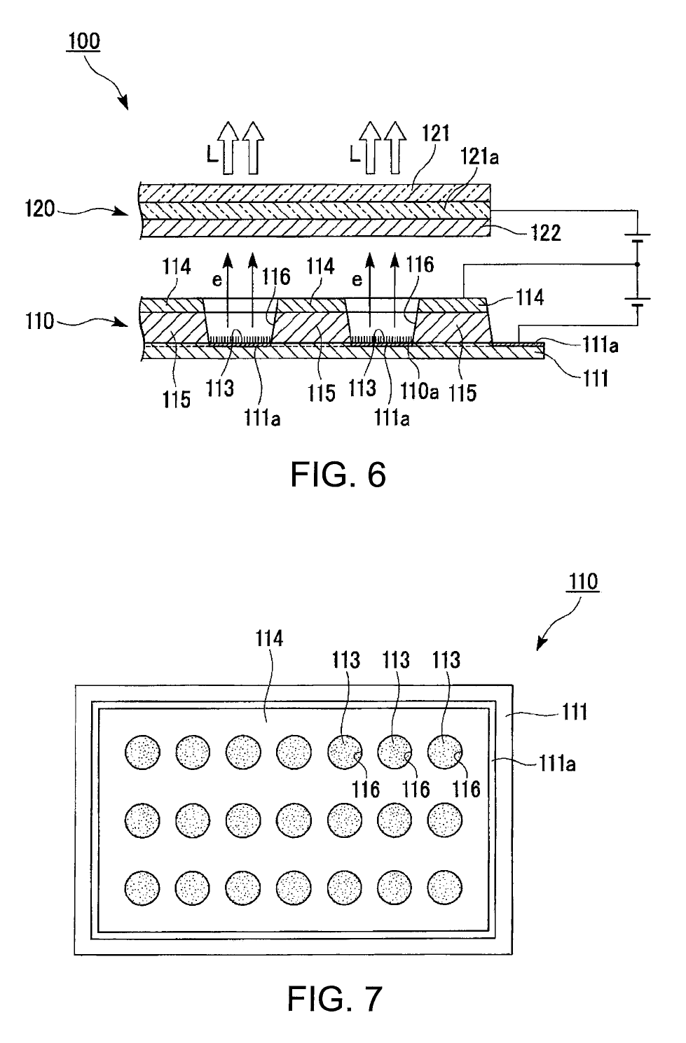

First, a structure of a light emitting device manufactured by the above described pattern forming method will be explained below. FIG. 6 is a sectional view illustrating a light emitting device 100 manufactured by the above described pattern forming method. The light emitting device 100 is configured of a cathode device (cathode section) 110 and an anode device (anode section) 120 opposed to each other at a prescribed interval.

The cathode device 110 is adapted to emit electrons to the anode device 120. The cathode device 110 is configured of a cathode substrate 111, a carbon nanotube layer (electron emitting member) 113 formed on the cathode substrate 111 and adapted to emit electrons, a grid (electrode member) 114 formed of an electrode for allowing the carbon nanotube layer 113 to emit the electrons, and an insulation layer (insulation film) 115 for forming a prescribed gap (approximately 10 micrometers in the embodiment) between the carbon nanotube layer 113 and the grid 114.

A cathode 111a to be electrically connected to an external power source is formed on the cathode substrate 111, and the carbon nanotube layer 113 is provided on the cathode 111a. When a positive voltage (drawing voltage) with respect to the cathode electrode 11a is applied to the grid 114, the electrons “e” are emitted from the carbon nanotube layer 113.

As shown in the plan view of FIG. 7, the cathode device 110 is so constituted that the grid 114 is formed on the plane face of the cathode substrate 111 to make its outer shape roughly rectangular, and a plurality of circular hole sections 116 are arranged at a prescribed distance such that the carbon nanotube layers 113 respectively disposed in a plurality of circular regions existing in the inner side of the region in the rectangular shape are exposed.

As shown in FIG. 6, the anode device 120 is adapted to emit a light by the electrons “e” emitted from the cathode device 110, and is configured of an anode substrate 121 and a fluorescent body 122 coated with a fluorescent material capable of emitting light by the electrons “e”. The anode substrate 121 is a light transmissive glass substrate, and an anode 121a formed of a transparent conductive film of ITO (Indium Tin Oxide) is provided to the anode substrate 121 on the face opposed to the cathode device 110. The fluorescent body 122 formed on the anode 121a by electrodeposition or the droplet discharge device IJ such that the size is roughly the same as that of the opposing cathode 111a. When the positive voltage (accelerated voltage) with respect to the grid 114 is applied to the anode 121a, the emitted electrons “e” are accelerated toward the fluorescent body 122 to collide with the fluorescent body 122, and then to generate a light L. The light passes through the anode substrate 121 to be exposed to the external section.

In the manufacturing of the cathode device 110 of the light emitting device 100 in the above described structure, it is possible to utilize the film pattern forming method of the invention. At that time, the region on the cathode substrate 111 on which the carbon nanotube layer 113 is formed is set to the pattern non-forming region 10 in FIG. 4A and the region on which the insulation layer 115 and the grid 114 are formed is set to the pattern forming region 20, and then the droplet discharge device is operated to manufacture the cathode device 110.

Specifically, firstly the above described liquid repellent film forming process and the film pattern forming process are alternately repeated by using the droplet discharge device IJ, thereby the pattern forming region on the cathode substrate 111 is coated with the liquid containing polyimide to form the insulation layer 115. Next, when the thickness of the insulation layer 115 reaches a prescribed level, the region on the insulation layer 115 is coated with an electrode material such as silver ink or the like by using the droplet discharge device IJ to form the grid 114 (an electrode film forming process).

After the grid 114 is formed, the liquid repellent film is removed by the liquid repellent film removing process, and then, the pattern non-forming region is coated with a droplet containing the carbon nanotube by the droplet discharge device IJ to form the carbon nanotube layer 113 (an electron emission film forming process), thereby the cathode device 110 can be manufactured.

Consequently, in this embodiment, the method for manufacturing the light emitting device 100 is described. The light emitting device 100 includes the cathode device 115 having the carbon nanotube layer 113, the grid 114 for allowing the carbon nanotube layer 113 to emit the electrons “e”, and the insulation layer 115 with the prescribed thickness provided between the carbon nanotube layer 113 and the grid 114, and the anode device 120 for emitting the light by virtue of the emitted electrons “e”. The manufacturing method has a constitution that includes the process of forming the insulation layer 115 by using the above described film pattern forming method, thereby the insulation layer 115 with the desired thickness can be formed.

That is, in this embodiment, the insulation layer 115 with the desired shape and thickness can be formed without using a process in which processing of exposing is carried out by laying out a mask on a photosensitive insulation layer as in a well known technique, resulting in decreasing of the cost.

In addition, the method for manufacturing light emitting device in this embodiment has a constitution that includes the electrode film forming process of forming the grid 114 by coating the insulation layer 115 with the droplet containing the electrode material after forming the insulation layer 115 with the prescribed thickness, the liquid repellent film removing process for removing the liquid repellent film after the electrode film forming process and the electron emission film forming process of coating the pattern non-forming region with the droplet containing the carbon nanotube to form the carbon nanotube layer 113. By adopting the above constitution, it is possible to manufacture the cathode device 110 of the light emitting device 100 by forming the grid 114 and the carbon nanotube layer 113 by using the film pattern forming method.

Method for Forming Contact Hole and Bump

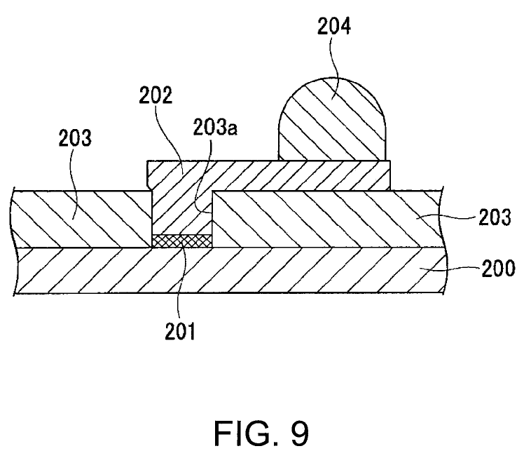

As shown in FIG. 9, the above described film forming method can be used to form a contact hole 203a which is so constituted that a wiring pattern 202 to be connected to an electrode 201 provided on a substrate 200 is exposed on an insulation layer 203, and to form a bump 204 with a prescribed thickness which is to be electrically connected to the exposed wiring pattern 202.

As to the contact hole 203a, for example, the region on which the contact hole 203a is to be formed is set to the pattern non-forming region, and then a hole section is formed on the insulation layer 203 by carrying out the above described film forming method, thereby forming the contact hole 203a. As to the bump 204, the region on which the bump 204 is to be formed is set to the pattern forming region, and then the bump 204 with a desired thickness and a shape can be formed by carrying out the above described pattern forming method by using a liquid material containing a metallic material.

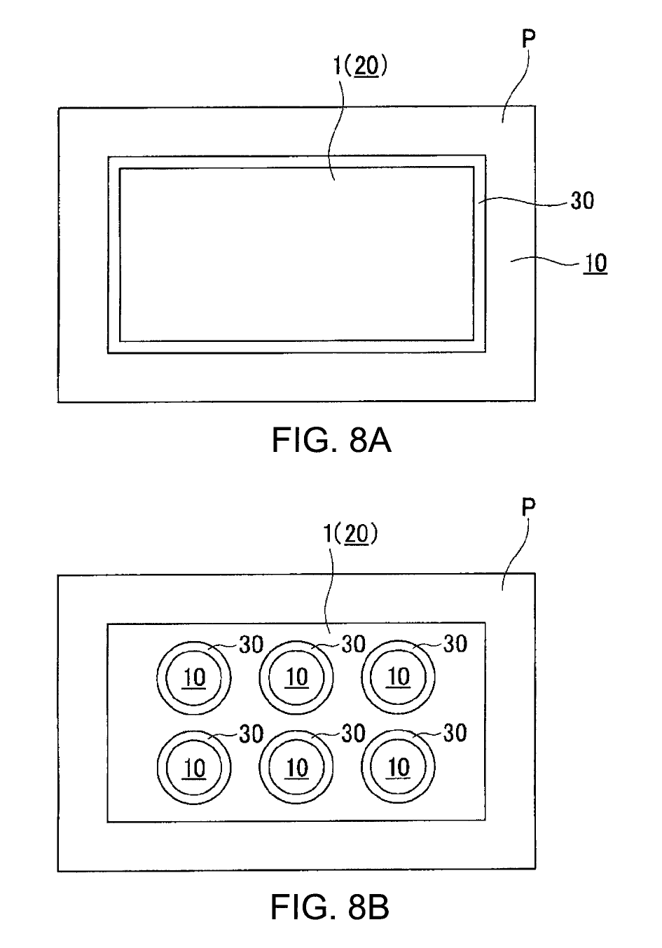

Note that the preferable embodiments of the invention are described above with reference to the accompanying drawings, but the invention is not limited to the embodiments. For example, in the above embodiment, it is described that the liquid repellent film 30 is formed so as to cover the pattern non-forming region 10 in the liquid repellent film forming process. However, the constitution in which the liquid repellent film 30 is formed in a line along the boundary of the pattern forming region 20 to be provided with the film pattern 1 as shown in FIGS. 8A, 8B, may be used in the liquid repellent film forming process. By adopting the above constitution, it is possible to form the film pattern 1 with the desired thickness at the low cost by suppressing the consumption of the liquid repellent material.

At that time, for example, the pattern forming region 20 indicated in FIG. 8A is disposed on the substrate P in the roughly rectangular shape, and the liquid repellent film 30 is formed so as to be overlapped with the boundary line between the pattern forming region 20 and the pattern non-forming region 10, thereby the film pattern 1 with the uniform prescribed thickness can be formed by suppressing the flowing of the functional liquid into the pattern non-forming region 10.

Likewise, in the FIG. 8B, the liquid repellent film 30 is formed so as to be overlapped with the boundary line between the film pattern 1 and the circular pattern non-forming region 10, thereby the film pattern 1 with the desired thickness can be formed by suppressing the flowing of the functional liquid into the pattern non-forming region 10.

In the above embodiment, while it is described that the liquid repellent film forming process is carried out before the film pattern forming process, the invention is not limited to the sequence of the processes so that the film pattern forming process can be carried out before the liquid repellent film forming process.

What is claim is:

1. A method for forming a film pattern on a pattern forming region disposed adjacent to a pattern non-forming region by coating the pattern forming region with a functional liquid, comprising:
(a) forming a liquid repellent film by coating the pattern non-forming region with a droplet containing a liquid repellent material having repellency to the functional liquid; and
(b) forming the film pattern by coating the pattern forming region adjacent to the liquid repellent film with the functional liquid,
wherein the step (a) and the step (b) are alternately repeated at least two times, respectively.

2. The method for forming a film pattern according to claim 1, wherein the liquid repellent film is formed in a line along a boundary between the pattern non-forming region and the pattern forming region in the step (a).

3. The method for forming a film pattern according to claim 1, further comprising:
(c) removing the liquid repellent film after forming the film pattern with a prescribed thickness; and
(d) forming a second film pattern by coating the pattern non-forming region with a second functional liquid, the pattern non-forming region being obtained by removing the liquid repellent film in the step (c).

4. A method for forming a contact hole by using the method for forming a film pattern according to claim 1.

5. A method for forming a bump by using the method for forming the film pattern according to claim 1.

6. A method for manufacturing a light emitting device having a cathode section including an electron emitting member, an electrode member for allowing the electron emitting member to emit electrons and an insulation film with a prescribed thickness provided between the electron emitting device and the electrode member, and an anode section for emitting light by the emitted electrons, comprising:
(e) forming the insulation film by the method for forming a pattern according to claim 1.

7. The method for manufacturing a light emitting device according to claim 6, further comprising:
(f) forming an electrode film by coating a portion on the insulation film with a droplet containing an electrode material constituting the electrode member after the step (e) of forming the insulation film with a prescribed thickness;
(g) removing the liquid repellent film formed in the step (a) after the step (f); and
(h) forming an electron emitting film by coating the pattern non-forming region with a droplet containing an electron emitting material constituting the electron emitting member, the pattern non-forming region being formed by removing the liquid repellent film in the step (g).
